(19) United States
(12) Patent Application Publication
(10) Pub. No.: US 2020/0347253 A1
(43) Pub. Date: Nov. 5, 2020

(54) MANUFACTURING PROCESS FOR ARTICLE BEARING TRANSFERRED PRINTED IMAGE AND RELATED ART

(71) Applicant: MATSUI SHIKISO CHEMICAL CO., LTD., KYOTO (JP)

(72) Inventors: Yosuke KITAGAWA, KYOTO (JP); Nobuyuki TONO, KYOTO (JP); Tomohiro MIZUHARA, KYOTO (JP); Yoshimasa MITSUMOTO, KYOTO (JP); Katsuya UOTOME, KYOTO (JP)

(21) Appl. No.: 16/962,716

(22) PCT Filed: Jan. 4, 2019
(86) PCT No.: PCT/JP2019/000025

§ 371 Date: Jul. 16, 2020

(30) Foreign Application Priority Data
Jan. 18, 2018 (JP) 2018-006803

(51) Int. Cl. C09D 11/34; B41M 3/12; C09J 175/04; C09J 7/35

(52) U.S. Cl. CPC C09D 11/34; B41M 3/12; D06P 5/30; C09J 7/35; C09J 175/04

(57) ABSTRACT

Provision of an article such as a garment made of a textile fiber product, which article bears a desired transferred printed image, while maintaining its essential properties, such as texture, to the maximum possible extent; a manufacturing process for the article; a transfer material for the transfer; and a material for obtaining the transfer material. The transfer material is produced by forming hot melt adhesive layer portion on specified post hoc printing areas in a specified face of a substrate so that it can be removed from the substrate, forming a post hoc printed image layer for showing a desired image on the adhesive layer portion by plateless printing. Heating the adhesive layer portion and post hoc printed image layer of the transfer material and pressing them against the object article for fusion bonding of the adhesive layer portion to the object article, to fix the adhesive layer portion and post hoc printed image layer to the object article upon cooling.

### BACKGROUND OF THE INVENTION

### 1. Field of the Invention

The present invention relates to a manufacturing process for an article bearing a transferred printed image on a garment consisting of a textile to fiber product or the like and related art.

### 2. Description of the Prior Art

Traditionally three major means are known to form a pattern on a textile fiber product that constitutes a garment or the like (generally a white textile fiber product or a textile fiber product colored by dyeing or the like).

First, a direct printing method is available to form a pattern by printing a color pigment ink on a white textile fiber product to form the pattern, or by printing a color pigment ink having a concealing property on a textile fiber product colored by dyeing or the like to form the pattern, or by forming a concealing layer with a white ink having a concealing property on a textile fiber product, and printing a color ink on the concealing layer.

Second, a thermal transfer method is available comprising stacking a release layer, a pattern layer, and an adhesive layer on a base sheet consisting of heat-resistant paper or synthetic resin film in this order to form a transfer sheet, thermocompression bonding the adhesive layer of the transfer sheet on a textile fiber product using a hot press or an iron to transfer a pattern, and then detaching the base sheet.

Third, a digitized method is available for directly printing a pigment ink on a textile fiber product in the absence of printing plate using an ink jet method.

The first method of direct printing imposes a large plate-making cost due to make screen plates for different colors, is not efficient because of necessity for a printing work for each textile fiber product to form a pattern, and requires a high skill for the printing work.

The second method of thermal transfer makes it possible to easily form a transfer sheet by printing an elevated temperature release layer, a pattern formation layer, and an adhesive layer on a base sheet with resin inks in this order using a printing machine, and also makes it possible to obtain a large number of transfer sheets at one time by forming large numbers of release layers, pattern layers, and adhesive layers on one base sheet, and splitting the base sheet.

In addition, by thermocompression bonding the adhesive layers on a textile fiber product using the transfer sheets and a hot press or an iron, it is possible to efficiently transfer and form fine, brilliant, and tough patterns (JP-A-HEI5-287686).

However, this method essentially requires a screen plate for every layer to manufacture the transfer sheets and also requires a number of screen plates corresponding to the number of colors in the pattern formation layer.

Therefore, cost and time are required to make the screen plates, which does not match the recent trend for smaller lot size, larger variety, and shorter delivery time in the manufacture and distribution of textile fiber products, particularly garments and the like.

In addition, labels for size, fiber material, laundry instructions, manufacturer, and place of origin, unlike brand marks and the like, often vary; in the first and second methods, to make a screen plate and manufacture a transfer sheet each time is going to become unfeasible because of the delivery time and price.

The third method is a method for forming an image on a textile fiber product in the absence of a printing plate as a solution to the problems with the first and second methods, and it does not necessitate manufacturing a screen plate; however, because an image should be formed on each textile fiber product using an ink jet machine, the third method cannot be said to be efficient in cases where an image is formed in only a portion of the textile fiber product, for example, labels for size, fiber material, laundry instructions, manufacturer, and place of origin. With regard to changes in labels for size, fiber material, laundry instructions, manufacturer, place of origin, and the like of the textile fiber product, it is difficult to meet the requirements for shorter delivery time and lower cost.

As a solution to these problems, there has been proposed a transfer sheet for printing a pattern formation layer using a plateless ink jet process (JP-4452004).

However, because the transfer sheet obtained using this method has an adhesive layer stacked on the entire surface of the substrate, the pattern transferred to the textile fiber product poses a problem that the resin component used in the adhesive layer hardens its texture and interferes with the air permeability, and thermocompression bonding during transfer processing makes the adhesive layer protrude and stain the hot press plate, and the protruding adhesive layer can adhere around the transferred pattern on the textile fiber product.

### PRIOR ART DOCUMENTS

JP-A-HEIS-287686

JP-4452004

### SUMMARY OF THE INVENTION

The present invention is intended to provide an article such as a garment made of a textile fiber product, which article bears a desired transferred printed image and meets demands for small quantity and large variety production, while maintaining its essential properties, such as texture, to the maximum possible extent; a manufacturing process for the article; a transfer material for the transfer; and a material for obtaining the transfer material.

The manufacturing process for an article bearing a transferred printed image and related art of the present invention can be described as follows:

(1) A manufacturing process for an article bearing a transferred printed image comprising:

an adhesive layer portion formation step for forming a hot melt adhesive layer portion on one or more specified post hoc printing areas in a specified face of a substrate, directly or via another layer, so that it can be removed from the substrate,

a post hoc printed image layer formation step for forming a post hoc printed image layer for showing a desired image on the adhesive layer portion by plateless printing, and

a transfer step for fusion bonding of the adhesive layer portion to the object article by heating the adhesive layer portion and post hoc printed image layer and pressing them against the object article, while the post hoc printed image layer is in contact with the object article, to fix the adhesive layer portion and post hoc printed image layer to the object article,

wherein the adhesive layer portion fixed to the object article and cooled is transparent or translucent, and a desired image shown by the post hoc printed image layer is allowed to be recognized or distinguished through the adhesive layer portion, while the substrate has been removed.

A post hoc printed image layer for showing a desired image is formed on a hot melt adhesive layer portion formed on one or more specified post hoc printing areas in specified face of a substrate by plateless printing. Hence, a post hoc printed image layer to show one or more kinds of desired image or a post hoc printed image layer to show an additional desired image as required can be separately formed post hock by plateless printing, and can be formed even little by little as required.

By bringing the post hoc printed image layer thus formed on the hot melt adhesive layer portion by plateless printing into contact with the object article, heating the adhesive layer portion and post hoc printed image layer, and pressing them against the object article, the adhesive layer portion and post hoc printed image layer can be fixed to the object article when the adhesive layer portion is fusion bonded to the object article and cooled or allowed to remain hot.

Because no hot melt adhesive layer portion is formed anywhere other than the area corresponding to the post hoc printing area in the object article, disadvantages from the unwanted hot melt adhesive layer portion can be avoided.

Because the adhesive layer portion and post hoc printed image layer is fixed to the object article, and the adhesive layer portion in a cooled state is transparent or translucent, a desired image shown by the post hoc printed image layer fixed to the object article can be recognized or distinguished through the adhesive layer portion, while in a state where the substrate has been removed.

(2) The process according to term (1) above, wherein the formation of the post hoc printed image layer for showing a desired image by plateless printing is achieved by ink jet printing.

(3) The process according to term (1) or (2) above, wherein the plateless printing of the post hoc printed image layer on the hot melt adhesive layer portion is performed so that the hot melt adhesive layer portion will be present in a periphery of the post hoc printed image layer.

(4) The process according to any one of terms (1) to (3) above, wherein the formation of the post hoc printed image layer for showing a desired image by plateless printing is achieved by printing to form a resin film.

(5) The process according to term (4) above, wherein the resin film is formed on the basis of an energy ray curable ink jet ink composition.

(6) The process according to term (5) above, wherein the resin film is formed by an energy ray curable ink jet ink composition comprising at least a polymerizable monomer and polymerizable oligomer that can be polymerized by an active radical, and a photopolymerization initiator, and the content amounts of the polymerizable monomer and polymerizable oligomer are 8 to 84 parts by mass and 5 to 40 parts by mass, respectively, per 100 parts by mass of the ink composition.

(7) The process according to term (5) or (6) above, wherein the resin film is formed by an energy ray curable ink jet ink composition that comprises at least a monofunctional polymerizable monomer and a bifunctional polymerizable monomer as polymerizable monomers, and the content amount of the monofunctional polymerizable monomer is 4 to 80 parts by mass, and the content amount of the bifunctional polymerizable monomer is 4 to 40 parts by mass, per 100 parts by mass of the ink composition.

(8) The process according to any one of terms (5) to (7) above, wherein the resin film is formed by an energy ray curable ink jet ink composition comprising a urethane acrylate oligomer as a polymerizable oligomer.

(9) The process according to any one of terms (4) to (8) above, wherein the hot melt adhesive layer portion and the resin film each comprises a urethane-series resin and can adhere firmly to each other.

(10) The process according to any one of terms (4) to (9) above, wherein the fixing force of the post hoc printed image layer by the resin film in a cooled state following the transfer step to the object article is lower than the fixing force of the hot melt adhesive layer portion, and the hot melt adhesive layer portion of the front side of the post hoc printed image layer retains the post hoc printed image layer by the resin film to the object article together with the hot melt adhesive layer portion in direct bonding to the object article in the periphery of the post hoc printed image layer.

(11) The process according to any one of terms (1) to (10) above, wherein the formation of a hot melt adhesive layer portion with resin ink on one or more specified post hoc printing areas of a specified face of the substrate, directly or via another layer, is performed by screen printing or another plate printing.

(12) The process according to any one of terms (1) to (11), further comprising a specified-image layer formation step for forming a specified-image layer on one or more specified specified-image layer areas in the specified face of the substrate, directly or via another layer, in a specified design, before the post hoc printed image layer formation step.

(13) The process according to any one of terms (1) to (12), further comprising a specified-image layer formation step for forming a specified-image layer on one or more specified specified-image layer areas in the hot melt adhesive layer portion, in a specified design, before the post hoc printed image layer formation step.

(14) The process according to term (13) above, wherein the formation of a specified-image layer on a hot melt adhesive layer portion is performed so that a hot melt adhesive layer portion will be present in a periphery of the specified-image layer, and the plateless printing of a post hoc printed image layer on the specified-image layer or hot melt adhesive layer portion is performed so that a hot melt adhesive layer portion will be present in a periphery of the post hoc printed image layer.

(15) An article comprising:

an object article, a printed image layer by resin film in close contact with the object article, a hot melt adhesive layer portion covering the front side of the printed image layer, and a hot melt adhesive layer portion directly bonded to the object article in a periphery of the printed image layer, wherein the fixing force of the printed image layer to the object article is lower than the fixing force of the hot melt adhesive layer portion, and the hot melt adhesive layer portion of the front side of the printed image layer retains the printed image layer by the resin film to the object article together with the hot melt adhesive layer portion in direct bonding to the object article in a periphery of the printed image layer, and wherein the hot melt adhesive layer portion is transparent or translucent, and the desired image shown by the printed image layer can be recognized or distinguished through the hot melt adhesive layer portion.

(16) The article according to term (15) above, wherein the printed image layer is formed with resin film by ink jet printing.

(17) The article according to term (16) above, wherein the resin film is formed with an energy ray curable ink jet ink composition.

(18) The article according to any one of terms (15) to (17) above, wherein a specified-image layer is present on the hot melt adhesive layer portion.

(19) A transfer material comprising:

a substrate,

a hot melt adhesive layer portion formed on one or more specified post hoc printing areas in a specified face of the substrate, directly or via another layer, so that it can be removed from the substrate, and a post hoc printed image layer for showing a desired image formed on the adhesive layer portion by plateless printing;

wherein the adhesive layer portion is fusion bonded to the object article by heating the adhesive layer portion and post hoc printed image layer and pressing them against the object article, while the post hoc printed image layer is in contact with an object article,

the adhesive layer portion is transparent or translucent, while the adhesive layer portion and post hoc printed image layer are fixed to the object article and cooled, and the desired image shown by the post hoc printed image layer can be recognized or distinguished through the adhesive layer portion, while the substrate has been removed.

(20) The transfer material according to term (19) above, wherein the formation of a post hoc printed image layer for showing a desired image by plateless printing is achieved by ink jet printing.

(21) The transfer material according to term (19) or (20) above, wherein the hot melt adhesive layer portion is present in a periphery of the post hoc printed image layer.

(22) The transfer material according to any one of terms (19) to (21) above, wherein the post hoc printed image layer for showing the desired image consists of a resin film.

(23) The transfer material according to term (22) above, wherein the resin film has been formed on the basis of an energy ray curable ink jet ink composition.

(24) The transfer material according to term (22) or (23) above, wherein the hot melt adhesive layer portion and the resin film each comprise a urethane resin and adhere firmly to each other.

(25) The transfer material according to any one of terms (22) to (24) above, wherein the adhesive layer portion is fusion bonded to the object article by heating the adhesive layer portion and post hoc printed image layer and pressing them against the object article, while the post hoc printed image layer is in contact with the object article;

the fixing force for the object article of the post hoc printed image layer by the resin film is lower than the fixing force of the hot melt adhesive layer portion, while the adhesive layer portion and post hoc printed image layer are fixed to the object article and cooled;

and the hot melt adhesive layer portion of the front side of the post hoc printed image layer, together with the hot melt adhesive layer portion directly bonded to the object article in a periphery of the post hoc printed image layer, retain the post hoc printed image layer by the resin film to the object article.

(26) The transfer material according to any one of terms (19) to (25) above, wherein the formation of the hot melt adhesive layer portion with resin ink on one or more specified post hoc printing areas in the specified face of the substrate directly or via another layer has been achieved by screen printing or another plate printing.

(27) The transfer material according to any one of terms (19) to (26) above, wherein a specified-image layer has been formed on one or more specified specified-image layer areas in the specified face of the substrate in a specified design directly or via another layer.

(28) The transfer material according to any one of terms (19) to (27) above, wherein a specified-image layer has been formed on one or more specified specified-image layer areas in the hot melt adhesive layer portion in a specified design.

(29) The transfer material according to term (28) above, wherein the hot melt adhesive layer portion is present in a periphery of a specified-image layer on the hot melt adhesive layer portion, and hot melt adhesive layer portion is present in a periphery of the post hoc printed image layer on the specified-image layer or hot melt adhesive layer portion.

(30) A material for transfer material comprises

a substrate,

a hot melt adhesive layer portion formed on one or more specified post hoc printing areas in a specified face of a substrate, directly or via another layer, so that it can be removed from the substrate,

wherein the adhesive layer portion is for being formed a post hoc printed image layer thereon by plateless printing,

the adhesive layer portion is fusion bonded to the object article by heating the adhesive layer portion and post hoc printed image layer and pressing them against the object article, while the post hoc printed image layer is in contact with an object article,

the adhesive layer portion is transparent or translucent, while the adhesive layer portion and post hoc printed image layer are fixed to the object article and cooled, and the desired image shown by the post hoc printed image layer can be recognized or distinguished through the adhesive layer portion, while the substrate has been removed.

(31) An ink jet ink composition to be used in plateless printing of a post hoc printed image layer for showing a desired image in the manufacturing process according to any one of terms (1) to (14) above.

According to the present invention, by bringing a post hoc printed image layer formed on a hot melt adhesive layer portion by plateless printing into contact with an object article, heating an adhesive layer portion and post hoc printed image layer and pressing them against an object article, the adhesive layer portion can be fusion bonded to the object article to fix the adhesive layer portion and post hoc printed image layer to the object article.

Because no hot melt adhesive layer portion is formed anywhere other than the area corresponding to the post hoc printing area in the object article, disadvantages from the unwanted hot melt adhesive layer portion can be avoided.

### DETAILED DESCRIPTION OF THE INVENTION

A mode for carrying out the present invention is described below.

The manufacturing process of the present invention for an article bearing a transferred printed image has an adhesive layer portion formation step for forming a hot melt adhesive layer portion, a post hoc printed image layer formation step for forming a post hoc printed image layer, and a transfer step for fixing the adhesive layer portion and post hoc printed image layer to the object article. “Hot melt” refers to a property that a surface of an adherend is wet by thermal liquefaction and then cooled and solidified to perform adhesive bonding with sufficient strength.

(1) Object Article

While object articles include, for example, colored or non-colored textile fiber products such as woven fabrics, knittings, and non-woven fabrics; fiber products made of such textile fiber products (e.g., garments such as sports wears, T-shirts, and polo shirts, hats and caps, mufflers, sox, neckties, handkerchiefs, towels, sheet covers, curtains, cloth tags), and leathers or leather-based products (e.g., garments, belts, footwear, caps and hats), stretchable and flexible articles having a finely undulated surface, including such textile fiber products or fiber products made of textile fiber products and leather products, as well as other articles, for example, non-flexible or non-stretchable articles or articles having a smooth surface.

(2) In the adhesive layer portion formation step for forming a hot melt adhesive layer portion, a hot melt adhesive layer portion is formed on one or more post hoc printing areas made in the specified face of the substrate, directly or via another layer, so that the adhesive layer portion can be removed from the substrate. It is possible that no hot melt adhesive layer portion is formed in at least part of other area than the area corresponding to the post hoc printing area in the specified face of the substrate. And it is possible that no hot melt adhesive layer portion is formed anywhere other than the area corresponding to the post hoc printing area in the specified face of the substrate.

It is possible, for example, to make a plurality of specified segments on the specified face of the substrate, and to make one or more identical post hoc printing areas for each of the segments or for each segment in a set of two or more segments.

(2-1) Substrate

Although the substrate that is the subject of formation of the hot melt adhesive layer portion is desirably in the form of a sheet, it is not always be so, provided that each step can be performed.

The substrate may have heat resistance, pressure resistance, and other properties to endure conditions for the thermocompression bonding transfer step (e.g., transfer temperature 100 degrees C. to 200 degrees C., transfer time 2 to 30 seconds, transfer pressure 10 to 500 kPa).

One or more post hoc printing areas are made in the specified face of the substrate at positions corresponding to the post hoc printed image layer that is formed later.

The entire face or at least the post hoc printing area of the specified face of the substrate allows a hot melt adhesive layer portion to be formed thereon so that the portion can be removed from the substrate. To this end, it is possible, for example, to form a release layer allowing the adhesive layer portion to be removed, in at least the post hoc printing area of the substrate, or to make at least the post hoc printing area of the substrate made of a material that allows the adhesive layer portion to be removed. The release layer may have previously been formed on the substrate.

Examples of materials used in the release layer include materials of good removability from the hot melt adhesive layer portion or the protective layer described below, such as wax, paraffin, silicone oil, silicone resin, and fluorine resin.

The release layer can be formed in all or a portion of the specified face of the substrate by, for example, coating or printing.

It is desirable that when a release layer is provided in the substrate, the entire substrate or at least a specified face to form the release layer have a surface smoothness suitable for the formation of the release layer.

Examples of sheet-like substrates that can be used include paper and synthetic resin films, with preference given to polyester films and polyimide films because of their heat resistance and surface smoothness. For transfer at relatively low temperature, a polyolefin film such as a polypropylene film may be used as a substrate.

The thickness of the sheet-like substrate is preferably, but is not limited to, approximately 50 to 200 micrometers, for example.

Acceptable forms of the sheet-like substrate include, in addition to rectangular sheets of specified dimensions and other cut-sheets, continuous substrates like cylindrically rolled ones (rolled sheets).

(2-2) Hot Melt Adhesive Layer Portion

The hot melt adhesive layer portion is intended to fix at least the post hoc printed image layer to the object article, and is formed on one or more specified post hoc printing areas in the specified face of the substrate directly or via another layer (e.g., release layer or the protective layer described below or both).

The hot melt adhesive layer portion is able to fusion bond to the object article under heating and pressurization, and is able to solidify by spontaneous cooling or other process of cooling to fix to the object article. The heating temperature may be a temperature that allows the hot melt adhesive layer portion of the transfer material of the present invention to melt with no melting, damage, or the like caused except in the hot melt adhesive layer portion.

The hot melt adhesive layer portion that can be fixed to the object article by fusion bonding under heating and pressurization and subsequent cooling and solidification can be formed by, for example,

a) using a resin ink having hot melt adhesiveness,

b) using an ink obtained by dispersing hot melt resin particles in resin ink, or

c) applying hot melt resin particles onto a layer formed with resin ink, and heating the layer to slightly melt the hot melt resin particle and retain them on the layer.

It is preferable that the formation of a hot melt adhesive layer portion with resin ink on one or more specified post hoc printing areas of a specified face of the substrate, directly or via another layer, be performed by screen printing or another method of plate printing.

The surface of the hot melt adhesive layer portion may not be a smooth surface but a surface having finely undulation.

It is preferable that polyurethane resin, polyester resin, nylon resin, or the like be used as resin in the resin ink having hot melt adhesiveness, and these resins may be used in a mixture.

If no pigment or concealing substance or the like is not contained in the resin ink used to form a hot melt adhesive layer portion, the hot melt adhesive layer portion may be transparent or translucent, while the printed image has been transferred by pressurized heating and cooling, and the desired image shown by the post hoc printed image layer may be recognized or distinguished through the adhesive layer portion, while the substrate has been removed.

It is desirable that the hot melt adhesive layer portion be suitable for fixation to a stretchable and flexible article.

It is preferable for suitability to fixation to a stretchable and flexible article that the hot melt resin particle be in the form of a powder of a urethane resin having an average particle diameter of 20 to 300 micrometers, a softening point of 70 to 130 degrees C., and a 100% modulus of 0.5 to 10.0.

The thickness of the hot melt adhesive layer portion may be, but is not limited to, approximately 30 to 200 micrometers, for example.

(2-3) Protective Layer

In the manufacturing process of the present invention for an article bearing a transferred printed image, there may be a protective layer formation step for providing a protective layer between the substrate or release layer and the hot melt adhesive layer portion.

The protective layer can be formed on one or more specified post hoc printing areas and/or specified-image layer areas of a specified face of the substrate, directly or via another layer (e.g., release layer).

The protective layer is to protect printed images formed on a post hoc printed image layer or the specified-image layer described below or the like transferred to an object article, and it is preferable that the protective layer cover the portion to be protected, have a sufficient strength for the protection, and be colorless and transparent.

Examples of materials used for the protective layer include polyurethane resin, polyacrylic acid ester resin, polyvinyl chloride resin, vinyl chloride/vinyl acetate copolymer resin, ethylene/vinyl acetate copolymer resin, styrene/butadiene copolymer resin, polyester resin, and nylon resin, with preference given to polyurethane resin.

To form a protective layer using such a resin, it is preferable that the resin be used after being prepared as a resin ink by dissolving and/or dispersing the resin in an organic solvent, dispersing the resin in water, or emulsifying the resin.

It is preferable that the protective layer be formed by screen printing or another method of plate printing, using such a resin ink.

(3) In the post hoc printed image layer formation step for forming a post hoc printed image layer (i.e., a step for forming a post hoc printed image layer on a material for transfer material obtained as described above to obtain a transfer material), a post hoc printed image layer for presenting a desired image is formed on the hot melt adhesive layer portion formed in the adhesive layer portion formation step by plateless printing.

(3-1) Plateless Printing of Post Hoc Printed Image

Plateless printing of a post hoc printed image on a hot melt adhesive layer portion can be performed by, for example, ink jet printing, thermal transfer printing, toner (colored resin powder or microparticle) printing (charged-toner transfer fixation and the like), and the like.

The printed image formed by the post hoc printed image layer may be, for example, a drawing, letter, figure, or symbol, or a combination of two or more thereof, and may be a monochromic, dichromic, or more multiple color pattern.

A preferable method of plateless printing is a printing to form a resin film as a post hoc printed image layer, particularly ink jet printing. The ink used for ink jet printing may be an energy ray curable ink or an aqueous or oil-based ink jet ink. Particularly preferred is an energy ray curable ink because of high color development and concealing properties for the post hoc printed image layer.

The plateless printing may be, for example, printing to form a non-hot-melting resin film as a post hoc printed image layer, particularly ink jet printing (e.g., ink jet printing with energy ray curable, aqueous or oil-based ink). A non-hot-melting resin film refers to a resin film that does not show hot-melting property at least at temperatures not exceed the temperatures suitable for the fusion bonding of the hot melt adhesive layer portion to the object article (e.g., textile fiber products).

It is preferable that the ink used for the ink jet printing be an ink with good fixability to the hot melt adhesive layer portion.

The ink jet method for ink jet printing is not subject to limitations; examples include the charge control method to eject an ink by means of an electrostatic induction force, the drop-on-demand method based on the oscillating pressure of a piezo device (pressure pulse method), the acoustic ink jet method based on radiation pressure applied to the ink in the form of an acoustic beam converted from an electric signal, and the thermal ink jet method based on the pressure resulting from bubbles formed by heating the ink.

Devices that can be used for energy ray irradiation to the ink ejected onto the hot melt adhesive layer portion in the ink jet printing of the energy ray curable ink include, in addition to mercury lamps and metal halide lamps, ultraviolet LED and ultraviolet laser. The energy ray is preferably applied to the ink composition between an elapse of 1 ms and 1000 ms after the ejection of the ink composition onto the hot melt adhesive layer portion. If the time elapsed is less than 1 ms, unforeseeable events can arise because of exposure of the head to the energy ray due to too short a distance between the head and the ray source. If the time elapsed exceeds 1000 ms, image quality tends to be deteriorated by ink bleeding, particularly when using an ink of multiple colors.

(3-2) By performing the plateless printing of the post hoc printed image layer on the hot melt adhesive layer portion so that the periphery of the post hoc printed image layer will be identical to the periphery of the hot melt adhesive layer portion, it is possible to prevent to the maximum possible extent the texture and air permeability of the object article from being affected.

(3-3) Plateless printing of the post hoc printed image layer on the hot melt adhesive layer portion can be performed so that a hot melt adhesive layer portion (a portion where no post hoc printed image layer has been formed on the hot melt adhesive layer portion) will be present in the periphery of the post hoc printed image layer.

When both an outer periphery and an inner periphery are present as in the case of circular portions of letters and patterns, a periphery includes the outer periphery and inner periphery. It is desirable that the periphery be the whole circumference.

The protruding width of the periphery of the hot melt adhesive layer portion from the periphery of the post hoc printed image layer may be, for example, 0.1 to 2.0 mm, preferably 0.5 to 1.0 mm, and may also be constant. With regard to the wide portion of the post hoc printed image layer, it is preferable that the protruding width of the periphery of the hot melt adhesive layer portion from the periphery of the post hoc printed image layer be relatively large.

With regard to the post hoc printed image layer by resin film formed on a hot melt adhesive layer portion with an energy ray curable ink, while the fixing force for the object article is likely to be lower than the fixing force of the hot melt adhesive layer portion (e.g., 50% or less, 30% or less, 20% or less) and insufficient when the hot melt adhesive layer portion and post hoc printed image layer are cooled and fixed to the object article after heating (e.g., 200 degrees C. or lower) and pressurization in the subsequent transfer step, heat pressurization and cooling in the transfer step allows the hot melt adhesive layer portion of the periphery of the post hoc printed image layer to bond directly to the object article, and allows the hot melt adhesive layer portion of the front side of the post hoc printed image layer, together with the hot melt adhesive layer portion bonded directly to the object article, that is, the hot melt adhesive layer portion of the periphery of the post hoc printed image layer, to retain the post hoc printed image layer by resin film to the object article.

In this case, by adjusting the properties of the energy ray curable ink, the relationship between the ink and the hot melt adhesive layer portion, and other aspects (e.g., by increasing to the maximum possible extent the affinity of the post hoc printed image layer by ink resin film and the hot melt adhesive layer portion using similar types of resin [preferably both are urethane-series resins], and by making the properties of the post hoc printed image layer by ink resin film allow the layer to come into close contact with the surface of the object article by heat pressurization transfer, including the case wherein the surface has undulations, and to have an appropriate modulus), the front side of the post hoc printed image layer comes into close contact with, or adhesion to, the hot melt adhesive layer portion, and the back side of the post hoc printed image layer comes into close contact with the surface of the object article (including close contact according to any fine undulation on the surface of the object article, such as in textile fiber products), to allow them to well follow the deformation, stretching, and the like of the object article, whereby the hot melt adhesive layer portion of the front side of the post hoc printed image layer and the hot melt adhesive layer portion of the periphery of the post hoc printed image layer together well retain the post hoc printed image layer by resin film on the object article.

(3-4) The energy ray curable ink for ink jet printing to form a post hoc printed image layer by plateless printing may be, for example, a composition comprising a polymerizable compound, a photopolymerization initiator, a pigment (coloring agent), a pigment dispersing agent, and other additives. However, this is not to be construed as limiting; for example, the coloring agent used may be a dye, with preference from the viewpoint of weather fastness given to a pigment. If a colorless ink is used, the ink does not contain a coloring agent.

(i) Polymerizable Compound

The polymerizable compound is not subject to limitations, as far as it is a compound that can be polymerized by an active radical generated from a photopolymerization initiator by the action of light or the like, and commonly known conventional monofunctional polymerizable monomers, multifunctional polymerizable monomers and polymerizable oligomers can be used alone or in combination so that the desired ink composition characteristics are obtained.

The term “monomer” as used herein refers to one having a weight-average molecular weight of less than 800, and the term “oligomer” refers to one having a weight-average molecular weight of 800 or more and 10,000 or less. The “weight-average molecular weight” as used herein means a value calculated from the structure of a monomer or a polystyrene-based weight-average molecular weight of an oligomer as measured using gel permeation chromatography (GPC).

The monofunctional polymerizable monomer is a polymerizable monomer that has one ethylenic double bond in its molecular structure and that hardens upon energy ray irradiation, and its examples include monofunctional (meth)acrylate compounds, (meth)acrylamide compounds, and aromatic vinyl compounds.

Examples of monofunctional (meth)acrylate compounds include hexyl (meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, 2-ethylhexyl diglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy)ethyl (meth)acrylate, 2-(2-butoxyethoxy)ethyl (meth)acrylate, 2,2,2-trifluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, cyclic trimethylolpropaneformal (meth)acrylate, tetrahydrofurfuryl (meth)acrylate, hydroxyalkyl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, dimethylaminoethyl (meth)acrylate, diethylaminoethyl (meth)acrylate, dimethylainopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethyl ether (meth)acrylate, polyethylene oxide (meth)acrylate, oligoethylene oxide (meth)acrylate, oligoethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligopropylene oxide monoalkyl ether (meth)acrylate, 2-methacryloyloxethylsuccinic acid, 2-methacryloyloxyhexahydrophthalic acid, 2-methacryloyloxyethyl-2-hydroxypropyl phthalate, butoxydiethylene glycol (meth)acrylate, trifluoroethyl (meth)acrylate, perfluorooctylethyl (meth)acrylate, 2-hydroxy-3-phenoxypropyl (meth)acrylate, EO-modified phenol (meth)acrylate, EO-modified cresol (meth)acrylate, EO-modified nonylphenol (meth)acrylate, PO-modified nonylephenol (meth)acrylate, and EO-modified-2-ethylhexyl (meth)acrylate.

The term “(meth)acrylate” as used herein refers to at least one kind selected from the group consisting of acrylates and methacrylates, which may include (meth)acrylamide compounds and N-vinyl compounds. Examples of (meth)acrylamide compounds include (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide, and (meth)acryloylmorpholine. Examples of N-vinyl compounds include N-vinylcaprolactam, N-vinylformamide, N-vinylcarbazole, N-vinylacetamide, and N-vinylpyrrolidone.

Examples of aromatic vinyl compounds include styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, vinylbenzoic acid methyl ester, 3-methylstyrene, 4-methylstyrene, 3-ethylstyrene, 4-ethylstyrene, 3-propylstyrene, 4-propylstyrene, 3-butylstyrene, 4-butylstyrene, 3-hexyl styrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-t-butoxycarbonylstyrene, 4-methoxystyrene, and 4-t-butoxystyrene.

The multifunctional polymerizable monomer is a polymerizable monomer that has two or more ethylenic double bonds in its molecular structure and that hardens upon an energy ray irradiation, and its examples include bifunctional, trifunctional, tetrafunctional, pentafunctional, and hexafunctional (meth)acrylate compounds.

Examples of bifunctional (meth)acrylate compounds include 1,6-hexanediol di(meth)acrylate, 1,10-decanediol di(meth)acrylate, neopentyl glycol di(meth)acrylate, 2,4-dimethyl-1,5-pentanediol di(meth)acrylate, butylethylpropanediol (meth)acrylate, ethoxylated cyclohexane methanol di(meth)acrylate, polyethylene glycol di(meth)acrylate, oligoethylene glycol di(meth)acrylate, ethylene glycol di(meth)acrylate, 2-ethyl-2-butyl-butanediol di(meth)acrylate, neopentyl glycol hydroxypivalate di(meth)acrylate, EO-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate, and tricyclodecane di(meth)acrylate.

Examples of trifunctional and higher functional (meth)acrylate compounds include trifunctional (meth)acrylates such as trimethylol propane tri(meth)acrylate, trimethylolethane tri(meth)acrylate, trimethylol propane alkylene oxide-modified tri(meth)acrylate, pentaerythritol tri(meth)acrylate, dipentaerythritol tri(meth)acrylate, trimethylol propanetris((meth)acryloyloxypropyl) ether, isocyanuric acid alkylene oxide-modified tri(meth)acrylate, propionic acid dipentaerythritol tri(meth)acrylate, tris((meth)acryloyloxyethyl) isocyanurate, hydroxypivalaldehyde-modified dimethylol propane tri(meth)acrylate, sorbitol tri(meth)acrylate, propoxylated trimethylolpropane tri(meth)acrylate and ethoxylated glycerol triacrylate; tetrafunctional (meth)acrylates such as pentaerythritol tetra(meth)acrylate, sorbitol tetra(meth)acrylate, ditrimethylol propane tetra(meth)acrylate, propionic acid dipentaerythritol tetra(meth)acrylate, and ethoxylated pentaerythritol tetra(meth)acrylate; pentafunctional (meth)acrylates such as ribitol penta(meth)acrylate and dipentaerythritol penta(meth)acrylate; and hexafunctional (meth)acrylates such as dipentaerythritol hexa(meth)acrylate, sorbitol hexa(meth)acrylate, phosphazene alkylene oxide-modified hexa(meth)acrylate, and caprolactone-modified dipentaerythritol hexa(meth)acrylate.

Examples of polymerizable oligomers include urethane acrylate oligomers, polyester acrylate oligomers, and epoxy acrylate oligomers.

The polymerizable oligomer is preferably a urethane acrylate oligomer. The urethane acrylate oligomer is preferred for the post hoc printed image layer by ink resin film to obtain close contact with the object article to be transferred by heat pressurization (including close contact according to the undulation when the surface of the object article has fine undulation like textile fiber products) and flexibility that well follows the deformation, stretching, and the like of the object article, and it is preferable that a urethane acrylate oligomer be contained in the post hoc printed image layer because the layer containing urethane acrylate oligomer is good in affinity for, and close contact with or adhesion to, a hot melt adhesive layer portion made preferably of a urethane-series material such as polyurethane resin.

An aliphatic urethane acrylate oligomer comprising an aliphatic isocyanate and an acrylate having a hydroxy group is preferable as the urethane acrylate oligomer for the post hoc printed image layer by ink resin film in obtaining the above-described close contact with the object article to be transferred by heat pressurization and flexibility that well follows the deformation, stretching, and the like of the object article, and good light fastness, and other aspects.

The weight-average molecular weight of the polymerizable oligomer (weight-average molecular weight 800 or more) may be 5000 or less, preferably 900 or more and 3500 or less. Provided that the weight-average molecular weight of the polymerizable oligomer falls in the above-described range, it will be possible to make the ink composition less viscous, whereby it is possible to impart sufficient flexibility to the post hoc printed image layer by the ink resin film (coating). If the molecular weight of the oligomer used is too high, the viscosity of the ink composition obtained will increase, which in turn can make it impossible to ensure stable ink ejecting performance in ink jet printing, because the viscosity of the oligomer tends to increase with increasing molecular weight.

The polymerizable oligomer, when polymerized alone, preferably has a glass transition temperature (Tg) of 30 degrees C. or lower, more preferably has a glass transition temperature of 25 degrees C. or lower. When the polymerizable oligomer is polymerized alone, its glass transition temperature is preferably −50 degrees C. or higher, more preferably −30 degrees C. or higher. Provided that the glass transition temperature of the polymerizable oligomer falls in the above-described range, it is possible to obtain an ink composition having adequate coating flexibility. If the glass transition temperature is too high, it will become difficult to impart sufficient coating flexibility, and if the glass transition temperature is too low, the coating surface will soften and become likely to produce stickiness.

Examples of commercial products that can be used as polymerizable urethane acrylate oligomers include EBECRYL210, EBECRYL230, EBECRYL270, EBECRYL284, EBECRYL264, EBECRYL265, EBECRYL8402, EBECRYL8804, EBECRYL8411, EBECRYL8807, EBECRYL3708, EBECRYL745, KRM8098, KRM7735, and KRM8296, manufactured by DAICEL-ALLNEX Ltd.; and CN980, CN981, CN982, CN991, CN996, CN9001, CN9002, CN9004, CN9007, CN9009, CN9014, CN9178, CN9893, CN971, CN973, and CN2256, manufactured by SARTOMER.

By using such a monofunctional polymerizable monomer, multifunctional polymerizable monomer, or polymerizable oligomer chosen optionally as the polymerizable compound, it is possible to obtain an ink composition capable of forming a post hoc printed image layer showing excellent close contact with the object article when transferred to an object article (including those having fine undulation on the surface and those having flexibility or stretchability, such as textile fiber products) and showing excellent washing fastness when transferred to an object article to be subjected to laundering.

With regard to the content amounts of polymerizable monomer and polymerizable oligomer in the ink composition with the use of a polymerizable oligomer as a polymerizable compound, in addition to a polymerizable monomer, it is preferable that the content amount of the polymerizable monomer be 8 to 84 parts by mass, and the content amount of the polymerizable oligomer be 5 to 40 parts by mass, per 100 parts by mass of the ink composition. If the content amount of the polymerizable oligomer is less than 5 parts by mass, no sufficient flexibility will be obtained, and if the content amount exceeds 40 parts by mass, the ink composition can become too viscous for an ink composition because of relatively high viscosity of the polymerizable oligomer, which in turn can make ink ejection in ink jet printing unstable.

It is preferable that the polymerizable monomer in the ink composition comprises at least a monofunctional polymerizable monomer and a bifunctional polymerizable monomer, that the content amount of the monofunctional polymerizable monomer be 4 to 80 parts by mass per 100 parts by mass of the ink composition (may be 4 to 60 parts by mass), and that the content amount of the bifunctional polymerizable monomer be 4 to 40 parts by mass. In this range, it is possible to obtain an ink composition capable of forming a post hoc printed image layer showing excellent flexibility when transferred to an object article (including those having fine undulation on the surface and those having flexibility or stretchability, such as textile fiber products) and showing excellent washing fastness when transferred to an object article to be subjected to laundering. With regard to the content amount of the monofunctional polymerizable monomer per 100 parts by mass of the ink composition, the upper limit is more preferably 75 parts by mass, and the lower limit is more preferably 50 parts by mass and further preferably 55 parts by mass. With regard to the content amount of the bifunctional polymerizable monomer per 100 parts by mass of the ink composition, the upper limit is more preferably 30 parts by mass, and the lower limit is more preferably 10 parts by mass.

(ii) Photopolymerization Initiator

It is preferable that the photopolymerization initiator be contained in an ink composition to initiate polymerization by means of low-energy irradiation.

Examples of such photopolymerization initiators include acylphosphine oxide-series photopolymerization initiators, alpha-aminoalkylphenone-series photopolymerization initiators, thioxanthone-series photopolymerization initiators, aryl alkyl ketone-series photopolymerization initiators, oxime ketone-series photopolymerization initiators, acyl phosphonate-series photopolymerization initiators, S-phenyl thiobenzoate-series photopolymerization initiators, titanocene-series photopolymerization initiators, aromatic ketone-series photopolymerization initiators, benzyl-series photopolymerization initiators, quinone derivative-series photopolymerization initiators, and ketocoumarine-series photopolymerization initiators.

It is preferable that the ink composition contain at least one kind of photopolymerization initiator selected from the group consisting of acylphosphine oxide-series photopolymerization initiators, alpha-aminoalkylphenone-series photopolymerization initiators, and thioxanthone-series photopolymerization initiators. Use of such a photopolymerization initiator makes it possible to impart sufficient curability to the post hoc printed image layer by resin film (coating) of the ink.

Examples of acylphosphine oxide-series photopolymerization initiators include 2,4,6-trimethylbenzoyldiphenylphosphine oxide, 2,6-dimethoxybenzoyldiphenylphosphine oxide, 2,6-dichlorobenzoyldiphenylphosphine oxide, 2,3,5,6-tetramethylbenzoyldiphenylphosphine oxide, 2,6-dimethylbenzoyldiphenylphosphine oxide, 4-methylbenzoyldiphenylphosphine oxide, 4-ethylbenzoyldiphenylphosphine oxide, 4-isopropylbenzoyldiphenylphosphine oxide, 1-methylcyclohexanoylbenzoyldiphenylphosphine oxide, bis(2,4,6-trimethylbenzoyl)-phenylphosphine oxide, 2,4,6-trimethylbenzoylphenylphosphinic acid methyl ester, 2,4,6-trimethylbenzoylphenylphosphinic acid isopropyl ester, and bis(2,6-dimethoxybenzoyl)-2,4,4-trimethylpentylphosphine oxide. These may be used alone or in mixture. Examples of commercially available acylphosphine oxide-series photopolymerization initiators include IRGACURETPO from BASF Company.

Examples of alpha-aminoalkylphenone-series photopolymerization initiators include 2-methyl-1[4-(methylthio)phenyl]-2-morpholinopropan-1-one, 2-benzyl-2-dimethylamino-1-(4-morpholinophenyl)butanone-1, and 2-methyl-1-[4-(methoxythio)-phenyl]-2-morpholinopropan-2-one. These may be used alone or in mixture. Examples of commercially available alpha-aminoalkylphenone-series photopolymerization initiators include IRGACURE 369 and IRGACURE 907 from BASF Company.

Examples of thioxanthone-series photopolymerization initiators include thioxanthone, 2-methylthioxanthone, 2-ethylthioxanthone, 2-isopropylthioxanthone, 4-isopropylthioxanthone, 2-chlorothioxanthone, 2,4-dimethylthioxanthone, 2,4-diethylthioxanthone, 2,4-dichlorothioxanthone, and 1-chloro-4-propoxythioxanthone. These may be used alone or in mixture. Examples of commercially available thioxanthone-series photopolymerization initiators include KAYACURE DETX-S from Nippon Kayaku Co., Ltd. and Chivacure ITX from DOUBLE BOND CHEMICAL Company.

(iii) Pigment (Coloring Agent)

An inorganic pigment or an organic pigment or both can be used as the pigment.

Examples of inorganic pigment include titanium oxide, zinc white, zinc oxide, Tripon, iron oxide, aluminum oxide, silicon dioxide, kaolinite, montmorillonite, talc, barium sulfate, calcium carbonate, silica, alumina, cadmium red, red iron oxide, molybdenum red, chrome vermilion, molybdate orange, yellow lead, chrome yellow, cadmium yellow, yellow iron oxide, titanium yellow, chromium oxide, viridian, cobalt green, titanium cobalt green, cobalt chrome green, ultramarine, ultramarine blue, Prussian blue, cobalt blue, cerulean blue, manganese violet, cobalt violet, mica, and carbon black consisting of acidic, neutral, or alkaline carbon.

Examples of organic pigments include azo pigments, azomethine pigments, polyazo pigments, phthalocyanine pigments, quinacridone pigments, anthraquinone pigments, indigo pigments, thioindigo pigments, quinophthalone pigments, benzimidazolone pigments, and isoindoline pigments. Furthermore, hollow particles of crosslinked acrylic resin and the like may be used as organic pigments.

Examples of pigments having a cyan color include C.I. pigment blue 1, C.I. pigment blue 2, C.I. pigment blue 3, C.I. pigment blue 15, C.I. pigment blue 15:1, C.I. pigment blue 15:3, C.I. pigment blue 15:4, C.I. pigment blue 16, C.I. pigment blue 22, and C.I. pigment blue 60. Preference from the viewpoint of weather fastness, coloring power, and other aspects is given to the use of C.I. pigment blue 15:3 or C.I. pigment blue 15:4 or both.

Examples of pigments having a magenta color include C.I. pigment red 5, C.I. pigment red 7, C.I. pigment red 12, C.I. pigment red 48 (Ca), C.I. pigment red 48 (Mn), C.I. pigment red 57 (Ca), C.I. pigment red 57:1, C.I. pigment red 112, C.I. pigment red 122, C.I. pigment red 123, C.I. pigment red 168, C.I. pigment red 184, C.I. pigment red 202, C.I. pigment red 209, C.I. pigment red 254, and C.I. pigment violet 19. Preference from the viewpoint of weather fastness, coloring power, and other aspects is given to the use of at least one selected from the group consisting of C.I. pigment red 122, C.I. pigment red 202, C.I. pigment red 209, C.I. pigment red 254, and C.I. pigment violet 19.

Examples of pigments having a yellow color include C.I. pigment yellow 1, C.I. pigment yellow 2, C.I. pigment yellow 3, C.I. pigment yellow 12, C.I. pigment yellow 13, C.I. pigment yellow 14C, C.I. pigment yellow 16, C.I. pigment yellow 17, C.I. pigment yellow 73, C.I. pigment yellow 74, C.I. pigment yellow 75, C.I. pigment yellow 83, C.I. pigment yellow 93, C.I. pigment yellow 95, C.I. pigment yellow 97, C.I. pigment yellow 98, C.I. pigment yellow 109, C.I. pigment yellow 110, C.I. pigment yellow 114, C.I. pigment yellow 120, C.I. pigment yellow 128, C.I. pigment yellow 129, C.I. pigment yellow 130, C.I. pigment yellow 138, C.I. pigment yellow 139, C.I. pigment yellow 147, C.I. pigment yellow 150, C.I. pigment yellow 151, C.I. pigment yellow 154, C.I. pigment yellow 155, C.I. pigment yellow 180, C.I. pigment yellow 185, C.I. pigment yellow 213, and C.I. pigment yellow 214. Preference from the viewpoint of weather fastness and other aspects is given to the use of at least one kind selected from the group consisting of C.I. pigment yellow 74, C.I. pigment yellow 83, C.I. pigment yellow 109, C.I. pigment yellow 110, C.I. pigment yellow 120, C.I. pigment yellow 128, C.I. pigment yellow 138, C.I. pigment yellow 139, C.I. pigment yellow 150, C.I. pigment yellow 151, C.I. pigment yellow 154, C.I. pigment yellow 155, C.I. pigment yellow 213, and C.I. pigment yellow 214.

Examples of pigments having a black color include HCF, MCF, RCF, LFF, and SCF from Mitsubishi Chemical Corporation; Monarck and Reagal from Cabot Corporation; Color Black, Special Black, and Printex from Orion Engineered Carbons SA; TOKABLAC from Tokai Carbon Co., Ltd.; and Raven from Columbian Chemicals Company. It is preferable to use at least one selected from the group consisting of HCF #2650, HCF #2600, HCF #2350, HCF #2300, MCF #1000, MCF #980, MCF #970, MCF #960, MCF88, LFFMA7, MA8, MA11, MA77, and MA100 from Mitsubishi Chemical Corporation; and Printex 95, Printex 85, Printex 75, Printex 55, and Printex 45 from Orion Engineered Carbons SA.

The content amount of the coloring agent in the ink jet ink composition is preferably 0.1 part by mass or more, more preferably 0.3 parts by mass or more, and is preferably 20 parts by mass or less, more preferably 15 parts by mass or less, per 100 parts by mass of the ink jet ink composition. Provided that the content amount of the coloring agent falls in the above-described range, it is possible to obtain an ink composition retaining fluidity and having excellent image coloring power without increasing the viscosity of the ink composition.

When a pigment is used as the coloring agent, a pigment derivative and a pigment dispersing agent may be used to improve the dispersibility of the pigment.

Examples of pigment derivatives include pigment derivatives having a dialkylaminoalkyl group and pigment derivatives having a dialkylaminoalkylsulfonamide group.

Examples of pigment dispersing agents include ionic or nonionic surfactants and anionic, cationic, or nonionic polymeric compounds. In particular, preference from the viewpoint of dispersion stability is given to polymeric compounds having a cationic or anionic group. Examples of commercially available pigment dispersing agents include SOLSPERSE from Lubrizol Japan, Ltd., DISPERBYK from BYK Japan K.K., and EFKA from BASF Company.

It is preferable that the content amount of each of the pigment derivative and pigment dispersing agent in the ink composition be 0.05 parts by mass or more and 5 parts by mass or less per 100 parts by mass of the ink composition.

(iv) Other Additives

It is preferable that an ink storage stabilizer be contained as an additive.

The storage stability can be increased by containing an ink storage stabilizer. It is also preferable from the viewpoint of preventing head clogging due to polymerization of the polymerizable compound by heat energy that an ink storage stabilizer be added.

Examples of ink storage stabilizer include hindered amine compounds (HALS), phenolic antioxidants, and phosphoric antioxidants. Specifically, their examples include hydroquinone, metoquinone, benzoquinone, p-methoxyphenol, hydroquinone monomethyl ether, hydroquinone monobutyl ether, TEMPO, TEMPOL, cupferron AI, IRGASTAB UV-10, IRGAS TAB UV-22, FIRSTCURE ST-1 (manufactured by ALBEMARLE Company) t-butylcatechol, pyrogallol, and TINUVIN 111 FDL, TINUVIN 144, TINUVIN 292, TINUVIN XP40, TINUVIN XP60, and TINUVIN 400 from BASF Company. These ink storage stabilizers may be used alone or in combination.

The content amount of the ink storage stabilizer in the ink composition of the present invention is preferably 0.001 part by mass or more, more preferably 0.01 part by mass or more, and is preferably 5 parts by mass or less, more preferably 1 part by mass or less, per 100 parts by mass of the ink composition.

Examples of additives that may be blended as required in addition to ink storage stabilizers include commonly known ordinary additives such as surfactants, leveling agents, defoaming agents, antioxidants, pH regulators, charge imparting agents, bactericides, antiseptics, deodorants, charge controlling agents, wetting agents, antiskinning agents, and perfumes.

(v) How to Prepare an Ink Composition

An ink composition can be prepared using a commonly known method. Specifically, for example, a coloring agent, a portion or all of a polymerizable oligomer and/or polymerizable monomer that is a polymerizable compound, and as required, a pigment dispersing agent, are premixed to prepare a mixture, and the resulting mixture is dispersed using a disperser to prepare a primary dispersion. Examples of disperser include container-driving medium mills such as Disper Mixer; ball mills, centrifugal mills, and planetary ball mills; high-speed rotation mills such as sand mills; and medium agitation mills such as stirring tank mills.

Next, to the primary dispersion, any remaining portion of the polymerizable compound, a photopolymerization initiator, an interface adjuster such as a surfactant, and, as required, other additives such as an ink storage stabilizer, are added, and these ingredients are uniformly mixed using a mechanical stirrer. Examples of the mechanical stirrer include THREE ONE MOTOR, magnetic stirrers, Disper Mixer, and homogenizers. An ink composition may be mixed using a mechanical mixer such as a line mixer. To make the particles in the ink composition finer, the ink composition may be mixed using a disperser such as a bead mill or high-pressure jet mill.

(4) Specified-Image Layer

In the manufacturing process of the present invention for an article bearing a transferred printed image, in addition to transferring an optionally designed image by a post hoc printed image layer that can be formed on a hot melt adhesive layer portion with the optional design to the object article, a specified-image layer formation step for forming a specified-image layer in a specified-image layer area with a specified design before the post hoc printed image layer formation step may be present.

(4-1) The formation of a specified-image layer can be performed by one or both of forming a specified-image layer on one or more specified specified-image layer areas of the specified face of the substrate, directly or via another layer (e.g., release layer or protective layer or both), and forming the specified-image layer on one or more specified specified-image layer areas of a hot melt adhesive layer portion.

(4-2) The image formed by the specified-image layer may be, for example, a drawing, letter, figure, or symbol, or a combination of two or more thereof, and may be a monochromic, dichromic, or more multiple color pattern.

(4-3) It is preferable that the formation of the specified-image layer be performed by screen printing or another method of plate printing.

(4-4) The screen printing ink or other ink that can be used to form a specified-image layer may be formed with a material that is based mainly on a resin, that is colored with a coloring agent as required, and that may comprise other components.

Examples of resins that can be used include polyurethane resin, polyacrylic acid ester resin, polyvinyl chloride resin, vinyl chloride/vinyl acetate copolymer resin, ethylene/vinyl acetate copolymer resin, styrene/butadiene copolymer resin, polyester resin, and nylon resin.

Such resins can be selected from the viewpoint of, for example, fastness requirements, including washing fastness, friction fastness, and light fastness, when practically used as transferred and fixed to textile fiber products such as garments or other object articles, with preference in this regard given to aliphatic urethane resins.

Examples of the coloring agent include, but are not limited to, carbon black and iron oxide black pigment as black pigments; azo pigments, imidazolone pigments, and titanium yellow pigments as yellow pigments; azo pigments, quinacridone pigments, cromophtal pigments, diketopyrrolopyrrole pigments, and anthraquinone pigments as red pigments; phthalocyanine pigments as blue pigments; titanium oxide, aluminum silicate, and silicon oxide as white pigments; indanthrene pigments as orange pigments; dioxazine pigments as purple pigments; and phthalocyanine pigments as green pigments. In addition to metal powders such as aluminum powders, aluminum pastes, pearl pigments, brass powders, and glitters, special coloring agents such as thermochromic pigments, photochromic pigments, and luminescent pigments can be used as coloring agent. Coloring agents can be used not only alone, but also in mixture of two or more kinds.

(4-5) The specified-image layer area may not be overlapped with the post hoc printing area, may be consistent with the post hoc printing area, or may be partially overlapped with the post hoc printing area. These two or three (when two or more post hoc printing areas are set) settings may be made at one time.

In both cases where a specified-image layer is formed on one or more specified specified-image layer areas of a specified face of the substrate directly or via another layer (e.g., release layer or protective layer or both), or on one or more specified specified-image layer areas on a hot melt adhesive layer portion, the hot melt adhesive layer portion is formed in the corresponding position where a portion of the specified-image layer area does not overlap with the post hoc printing area, in the adhesive layer portion formation step.

When a specified-image layer is formed in one or more specified post hoc printing areas on the hot melt adhesive layer portion, and overlaps with the post hoc printing area, plateless printing of the overlapped portion of the post hoc printed image layer is performed on a specified-image layer.

In this case, formation of the specified-image layer on the hot melt adhesive layer portion can be performed so that a hot melt adhesive layer portion (a portion where no post hoc printed image layer has been formed on the hot melt adhesive layer portion) is present in a periphery of the specified-image layer, and plateless printing of the post hoc printed image layer on the specified-image layer or hot melt adhesive layer portion can be performed so that a hot melt adhesive layer portion (a portion where no post hoc printed image layer has been formed on the hot melt adhesive layer portion) is present in a periphery of the post hoc printed image layer.

When both an outer periphery and an inner periphery are present as in the case of circular portions of letters and patterns, a periphery includes the outer periphery and inner periphery. It is desirable that the periphery be the whole circumference.

The protruding width of the periphery of the hot melt adhesive layer portion from the periphery of the specified-image layer and/or post hoc printed image layer may be, for example, 0.1 to 2.0 mm, preferably 0.5 to 1.0 mm, and may also be constant. With regard to the wide portions of the specified-image layer and/or post hoc printed image layer, it is preferable that the protruding width of the periphery of the hot melt adhesive layer portion from the periphery of the specified-image layer and/or post hoc printed image layer be relatively large.

While the fixing force of a post hoc printed image layer by resin film formed on a hot melt adhesive layer portion with an ink jet ink composition, particularly an energy ray curable ink jet ink composition, for the object article is likely to be insufficient compared with the fixing force of the hot melt adhesive layer portion when the hot melt adhesive layer portion and post hoc printed image layer are cooled and fixed to the object article after heating (e.g., 200 degrees C. or lower) and pressurization in the subsequent transfer step, and the same is likely for the specified-image layer, heat pressurization and cooling in the transfer step allows the hot melt adhesive layer portion of a periphery of the specified-image layer and/or post hoc printed image layer to bond directly to the object article, and allows the hot melt adhesive layer portion of the front side of the specified-image layer and/or post hoc printed image layer, together with the hot melt adhesive layer portion bonding directly to the object article, that is, the hot melt adhesive layer portion of a periphery of the specified-image layer and/or post hoc printed image layer, to retain the specified-image layer and/or the post hoc printed image layer by resin film to the object article.

In this case, by adjusting the properties of the specified-image layer and/or the ink jet ink composition, particularly the energy ray curable ink jet ink composition, the relationship between the specified-image layer and/or the ink jet ink composition and the hot melt adhesive layer portion, and other aspects (e.g., by increasing to the maximum possible extent the affinity of the specified-image layer and/or the post hoc printed image layer by ink jet ink composition resin film and the hot melt adhesive layer portion, and the affinity of the specified-image layer and the post hoc printed image layer by ink jet ink composition resin film, using similar types of resin [preferably both are urethane-series resins], and by making the properties of the specified-image layer and/or the post hoc printed image layer by ink jet ink composition resin film allow the layer to come into close contact with the surface of the object article, including the surface with undulations, by heat pressurization transfer and to have an appropriate modulus), the front side of the specified-image layer and/or the post hoc printed image layer comes into close contact with, or adhesion to, the hot melt adhesive layer portion, and the back side of the specified-image layer and/or the post hoc printed image layer comes into close contact with the surface of the object article (including close contact according to any fine undulation on the surface of the object article, such as in textile fiber products), to allow them to well follow the deformation, stretching, and the like of the object article, whereby the hot melt adhesive layer portion of the front side of the specified-image layer and/or the post hoc printed image layer and the hot melt adhesive layer portion of the periphery of the specified-image layer and/or the post hoc printed image layer together well retain the specified-image layer and/or the post hoc printed image layer by resin film on the object article.

(5) In the transfer step for fixing the adhesive layer portion and post hoc printed image layer to the object article using the thus-obtained transfer material, the hot melt adhesive layer portion and post hoc printed image layer are heated and pressured to the object article, while the post hoc printed image layer is in contact with the object article, to fusion bond the hot melt adhesive layer portion to the object article, after which the adhesive layer portion and post hoc printed image layer are fixed by cooling to the object article.

When a specified-image layer is formed in one or more specified post hoc printing areas on a hot melt adhesive layer portion, and there is an overlapping portion with the post hoc printing area in the specified-image layer, the hot melt adhesive layer portion and specified-image layer and post hoc printed image layer are heated and pressured to the object article, while the specified-image layer and post hoc printed image layer are in contact with the object article, to fusion bond the hot melt adhesive layer portion to the object article, after which the adhesive layer portion and specified-image layer and post hoc printed image layer are fixed by cooling to the object article.

Thereafter, the substrate (and release layer if any) is removed from the hot melt adhesive layer portion (and a protective layer if any), and the hot melt adhesive layer portion (and a protective layer if any) appears on the object article; thus, printed images by the post hoc printed image layer can be recognized or distinguished through the hot melt adhesive layer portion (and a protective layer if present). In the presence of a specified-image layer, images by the specified-image layer can also be recognized or distinguished.

Heat pressurization is performed so that the hot melt adhesive layer portion melts with no melting, damage, or the like caused except in the hot melt adhesive layer portion, using, for example, a hot press or an iron. In usual cases such as when the substrate is in the form of a sheet, heating can be performed from the substrate side.

### EXAMPLES

The present invention is hereinafter described more detail by means of the following Examples and Comparative Examples, which, however, are not to be construed as limiting the present invention. “Part(s)” as mentioned in Examples and elsewhere mean “part(s) by mass” unless otherwise stated.

The following materials and apparatuses were used in Examples and Comparative Examples:

{Substrate}

An A3-sized polyester film of 100 micrometers thickness

{Elevated Temperature Release Layer Ink}

An ink for forming an elevated temperature release layer (release layer that is releasable at an elevated temperature) comprising a wax, an amide resin, a solvent, and a silicone-series defoaming agent (manufactured by Matsui Shikiso Chemical Co., Ltd.).

{Cooled Temperature Release Layer Ink}

An ink for forming a cooled temperature release layer (release layer that is releasable at a cooled temperature) comprising a silicone resin, a solvent, and a silicone-series defoaming agent (manufactured by Matsui Shikiso Chemical Co., Ltd.).

{Adhesive Layer Ink A}

An ink for forming a hot melt adhesive layer portion (colorless and transparent after heat pressurization and cooling) comprising a urethane resin, hot melt urethane resin particles, a solvent, and a silicone-series defoaming agent (manufactured by Matsui Shikiso Chemical Co., Ltd.)

{Protective Layer Ink}

An ink for forming a protective layer (colorless and transparent after heat pressurization and cooling) comprising a urethane resin, solvent, and a silicone-series defoaming agent (manufactured by Matsui Shikiso Chemical Co., Ltd.)

{Energy Ray Curable Ink Jet Ink}

The materials used in ink set 1 and ink set 2 are shown in Table 1.

For the inks in various colors in each of ink set 1 shown in Table 2 and ink set 2 shown in Table 3 (in the tables, the material amounts are shown in gram units), a coloring agent, a pigment dispersing agent, and a bifunctional monomer in the amounts shown in Table 2 and Table 3 were weighed out into a 100-cc polyethylene plastic bottle, 100 g of zirconia beads having a diameter of 0.3 mm was added, and the resulting mixture was dispersed using a paint conditioner (manufactured by Toyo Seiki Co., Ltd.) for 1 hour to prepare a dispersion.

The remaining materials in the amounts shown in Table 2 and Table 3 were each added to the resulting dispersion, the resulting each mixtures were each stirred using a magnetic stirrer for 30 minutes, after which the mixtures were subjected to suction filtration using a glass filter (manufactured by Kiriyama Glass Works Co.), whereby ink compositions in various colors were prepared to yield ink sets 1 and 2.

TABLE 1

| | Name | Description | Manufacturer | Tradename |
|---|---|---|---|---|
| Colorant | MA-8 | Acidic carbon | Mitsubishi | MA-8 |
| (pigment) | | black pigment | Chemical | |
| | P-BFS | Copper phthalocyanine | Clariant | Hostaperm |
| | | pigment | | Blue P-BFS |
| | RT-355D | Quinacridone | BASF | CINQUASIA |
| | | pigment | | Magenta |
| | | | | RT-355-D |
| | 4G01 | Disazo pigment | Clariant | Novoparm |
| | | | | Yellow 4G01 |
| | CR-60 | Titanium oxide | Ishihara | TIPAQUE |
| | | pigment | Sangyou | CR-60 |
| Pigment | Sol 32000 | Comb-shaped | Lubrizol | Solsperse |
| dispersant | | copolymer having | | 32000 |
| | | an alkaline | | |
| | | functional group | | |
| Monofunctional | PEA | 2-Phenoxyethyl | SARTOMER | SR339 |
| monomer | | acrylate | | |
| | NVCL | N-vinylcaprolactam | BASF | VCL |
| | HPPA | 2-Hydroxy-3- | Kyoeisha | M-600A |
| | | phenexypropyl | Chemical | |
| | | acrylate | | |
| Bifunctional | HDDA | 1,6-Hexanediol | SARTOMER | SR238 |
| monomer | | diacrylate | | |
| Polymerizable | EBECRYL | Aliphatic urethane | DAICEL- | EBECRYL |
| oligomer | 8402 | acrylate oligomer | ALLNEX | 8402 |
| Photopolymerization | IRGACURE | 2,4,6-Trimethylbenzoyl- | BASF | IRGACURE TPO |
| initiator | TPO | diphenyl-phosphine oxide | | |
| Surfactant | TEGOWET | Alkoxylated alcohol | Evonik | TEGO WET 500 |
| | 500 | | | |
| | UV3500 | Polydimethylsiloxane | BYK-Chemie | BYK-UV3500 |
| Stabilizer | HTEMPO | 4-Hydroxy-2,2,6,6- | Evonik | HYDROXY- |
| | | tetramethylpiperidine- | | TEMPO |
| | | N-oxyl | | |
| | HQ | Hydroquinone | Tokyo Chemical | Hydroquinone |
| | | | Industry | |

TABLE 2

| | | Ink set 1 | | | | |
|---|---|---|---|---|---|---|
| | Name | Black | Cyan | Magenta | Yellow | White |
| Colorant (pigment) | MA-8 | 2.0 | | | | |
| | P-BFS | | 2.0 | | | |
| | RT-355D | | | 4.0 | | |
| | 4G01 | | | | 2.0 | |
| | CR-60 | | | | | 10.0 |
| Pigment dispersant | Sol 32000 | 1.6 | 1.6 | 3.2 | 1.6 | 1.0 |
| Monofunctional | PEA | 34.9 | 34.9 | 31.3 | 34.9 | 32.5 |
| monomer | NVCL | | | | | |
| | HPPA | | | | | |
| Bifunctional monomer | HDDA | 25.0 | 25.0 | 25.0 | 25.0 | 25.0 |
| Polymerizable oligomer | EBECRYL 8402 | 20.0 | 20.0 | 20.0 | 20.0 | 15.0 |
| Photopolymerization | IRGACURE TPO | 15.0 | 15.0 | 15.0 | 15.0 | 15.0 |
| initiator | | | | | | |
| Surfactant | TEGOWET 500 | 1.0 | 1.0 | 1.0 | 1.0 | 1.0 |
| Stabilizer | HTEMPO | 0.5 | 0.5 | 0.5 | 0.5 | 0.5 |
| | HQ | 0.01 | 0.01 | 0.01 | 0.01 | 0.01 |
| | Total | 100.0 | 100.0 | 100.0 | 100.0 | 100.0 |

TABLE 3

| | | Ink set 2 | | | | |
|---|---|---|---|---|---|---|
| | Name | Black | Cyan | Magenta | Yellow | White |
| Colorant (pigment) | MA-8 | 2.0 | | | | |
| | P-BFS | | 2.0 | | | |
| | RT-355D | | | 4.0 | | |
| | 4G01 | | | | 2.0 | |
| | CR-60 | | | | | 10.0 |
| Pigment dispersant | Sol 32000 | 1.6 | 1.6 | 3.2 | 1.5 | 1.0 |
| Monofunctional | PEA | 35.8 | 35.8 | 32.2 | 35.8 | 28.4 |
| monomer | NVCL | 10.0 | 10.0 | 10.0 | 10.0 | 10.0 |
| | HPPA | 10.0 | 10.0 | 10.0 | 10.0 | 10.0 |
| Bifunctional monomer | HDDA | 25.0 | 25.0 | 25.0 | 25.0 | 25.0 |
| Polymerizable oligomer | EBECRYL 8402 | | | | | |
| Photopolymerization | IRGACURE TPO | 15.0 | 15.0 | 15.0 | 15.0 | 15.0 |
| initiator | | | | | | |
| Surfactant | UV3500 | 0.1 | 0.1 | 0.1 | 0.1 | 011 |
| Stabilizer | HTEMPO | 0.5 | 0.5 | 0.5 | 0.5 | 0.5 |
| | HQ | 0.01 | 0.01 | 0.01 | 0.01 | 0.01 |
| | Total | 100.0 | 100.0 | 100.0 | 100.0 | 100.0 |

{Ink Jet Printer Apparatus for Forming a Post Hoc Printed Image Layer}

UV-LED printer (UJF-3042HG, manufactured by Mimaki Engineering Co., Ltd.)

{Printing Conditions}

Resolution 900×600 dpi

Number of passes 6 passes

Black; K (black) 100% density printing

White; W (white) 100% density printing

Gray; printed in a desired gray color with a mixture of the three primary colors C (cyan), M (magenta), and Y (yellow) and over-printed at a 100% W (white) density (white printing to conceal a color and/or pattern of object article)

{Specified-Image Layer Ink}

An ink prepared by blending 10 parts of a black toner pigment (manufactured by Matsui Shikiso Chemical Co., Ltd.) comprising carbon black, a solvent, a urethane resin, and a dispersing agent per 100 parts of a clear ink (manufactured by Matsui Shikiso Chemical Co., Ltd.) comprising a urethane resin, a solvent, a silicone-series defoaming agent, and silicon oxide.

Transfer Materials 1-1 and 1-2

The elevated temperature release layer ink was printed on one face of the substrate using a 200-mesh screen plate having a total of 45 rectangles (9 rectangles arranged sidewise by 5 rectangles arranged lengthwise) each measuring 40.0 mm in length and 30.0 mm in width that were arranged at equal intervals, to provide elevated temperature release layers.

The adhesive layer ink A was printed on the elevated temperature release layers using a 100-mesh screen plate having 45 rectangles each measuring 39.2 mm in length and 29.2 mm in width that were arranged at equal intervals to share the same centers as those of the respective rectangles of the elevated temperature release layers, to provide hot melt adhesive layers.

The common printed images and individual printed images shown below were formed by printing as post hoc printed image layers in areas inside by 1.0 mm or more from the outer periphery on the hot melt adhesive layers of the respective rectangles each measuring 39.2 mm in length and 29.2 mm in width, using the ink jet printer apparatus filled with an energy ray curable ink jet ink (ink set 1 for transfer material 1-1, ink set 2 for transfer material 1-2; likewise below, ink set 1 for transfer materials tagged with −1 and ink set 2 for transfer materials tagged with −2).

The common printed images were reversed images of letters and the like such as “Made in Japan”, “100% cotton”, and “Please use a cleaning net”, and reversed images of patterns specified with symbol numbers 141, 200, 300, 445, 520, and 600 as defined by JIS L0001 (Textiles-Care labelling code using symbols).

The individual printed images were revested images for size indication of “XL” in the nine rectangles on the 1st line from above out of the 45 rectangles, “L” in the nine rectangles on the 2nd line, “M” in the nine rectangles on the 3rd line, “S” in the nine rectangles on the 4th line, and “XS” in the nine rectangles on the 5th line.

All of the above-described post hoc printed image layers were formed by printing to meet the above-described printing conditions for a gray color.

Thereafter, the substrates were cut along the rectangles of the elevated temperature release layers to obtain nine units for each size indication, namely a total of 45 units of transfer materials 1-1 and 1-2.

Transfer Materials 2-1 and 2-2

Elevated temperature release layers were provided on the substrates in the same manner as with transfer materials 1-1 and 1-2, and the protective layer ink was printed on the elevated temperature release layers using a 150-mesh screen plate having 45 rectangles each measuring 38.8 mm in length and 28.8 mm in width that were arranged at equal intervals to share the same centers as those of the respective rectangles of the elevated temperature release layers, to provide protective layers.

Hot melt adhesive layers were provided on the protective layers to share the same centers as those of the respective rectangles of the protective layers in the same manner as with transfer materials 1-1 and 1-2, and a post hoc printed image layers were formed in the same manner as with transfer materials 1-1 and 1-2, to obtain a total of 45 units of transfer materials 2-1 and 2-2.

Transfer Materials 3-1 and 3-2

In the same manner as with transfer materials 1-1 and 1-2, elevated temperature release layers and hot melt adhesive layers were provided on the substrates, and square patterns were printed with the specified-image layer ink using a 180-mesh screen plate with 45 squares measuring 10.0 mm in side length made thereon, so that 1a specified-image layer would be formed in each rectangular area on the hot melt adhesive layer where no post hoc printed image layer would be formed, to provide the specified-image layers.

Thereafter, post hoc printed image layers were formed in the same manner as with transfer materials 1-1 and 1-2 to obtain 45 units of transfer materials 3-1 and 3-2.

Transfer Materials 4-1 and 4-2

In the same manner as with transfer materials 1-1 and 1-2, except that the release layer ink was replaced with the cooled temperature release layer ink, 45 units of transfer materials 4-1 and 4-2 were obtained.

Transfer Materials 5-1 and 5-2

In the same manner as with transfer materials 3-1 and 3-2 except that the adhesive layer ink A was replaced with the adhesive layer ink B (manufactured by Matsui Shikiso Chemical Co., Ltd.), which comprises a polyester resin, hot melt nylon resin particles, a solvent, and a silicone-series defoaming agent, and which forms a hot melt adhesive layer portion (colorless and transparent after heat pressurization and cooling), 45 units of transfer materials 5-1 and 5-2 were obtained.

Transfer Materials 6-1 and 6-2

Elevated temperature release layers and hot melt adhesive layers were provided on the substrates in the same manner as with transfer materials 1-1 and 1-2.

Rectangular patterns measuring 39.2 mm in length and 29.2 mm in width were formed by printing so that their outline are the same as with the hot melt adhesive layers, as post hoc printed image layers on the hot melt adhesive layers, using the ink jet printer apparatus filled with the energy ray curable ink jet ink.

These post hoc printed image layers were formed by printing to meet the above-described printing conditions for a gray color.

Thereafter, the substrates were cut along the rectangles of the elevated temperature release layer to obtain 45 units of transfer material 6-1 and 6-2.

Transfer Materials NG 1-1 and 1-2

The adhesive layer ink was printed using a 100-mesh screen plate having 45 rectangles each measuring 39.2 mm in length and 29.2 mm in width that were arranged at equal intervals on one face of the substrate, to provide hot melt adhesive layers.

Thereafter, a post hoc printed image layers were formed in the same manner as with transfer materials 1-1 and 1-2 to obtain a total of 45 units of transfer materials NG 1-1 and 1-2.

Transfer Materials NG 2-1 and 2-2

Elevated temperature release layers were provided on the substrates in the same manner as with transfer materials 1-1 and 1-2, and a post hoc printed image layer was formed on each elevated temperature release layer in the same manner as with transfer materials 1-1 and 1-2, to obtain a total of 45 units of transfer materials NG 2-1 and 2-2.

Transfer Materials NG 3-1 and 3-2

The elevated temperature release layer ink was applied uniformly over the entire surface of one face of the substrate to provide an elevated temperature release layer.

The adhesive layer ink A was applied uniformly over the entire surface of the elevated temperature release layer to provide a hot melt adhesive layer.

A post hoc printed image layer was formed by printing on the hot melt adhesive layer in the same manner as with transfer materials 1-1 and 1-2, and each was cut into a rectangle measuring 39.2 mm in length and 29.2 mm in width, to obtain transfer materials NG 3-1 and 3-2.

### Examples 1 to 12 and Comparative Examples 1 to 6

The transfer materials obtained as described above were each heated and pressurized at 180 degrees C. and 35 kPa for 10 seconds using a hot press, while the post hoc printed image layer (in Examples 3 and 9, a post hoc printed image layer and specified-image layer) was in contact with the specified portion of the white cotton T-shirt.

For the transfer materials other than transfer materials 4-1 and 4-2, the substrate was removed from the white cotton T-shirt while remaining hot; after transfer materials 4-1 and 4-2 were cooled to room temperature, the substrate was removed.

With regard to Examples 1 to 6 and Comparative Examples 1 to 3, the transfer material stability, continuous transferability, and, post-transfer pattern clarity, stretchability and washing fastness were evaluated, and the results are shown in Table 4. The results of the same evaluations with regard to Examples 7 to 12 and Comparative Examples 4 to 6 are shown in Table 5.

TABLE 4

| | Example | Example | Example | Example | Example | Example | Comparative | Comparative | Comparative |
|---|---|---|---|---|---|---|---|---|---|
| | 1 | 2 | 3 | 4 | 5 | 6 | Example 1 | Example 2 | Example 3 |
| | Transfer | Transfer | Transfer | Transfer | Transfer | Transfer | Transfer | Transfer | Transfer |
| Transfer | material | material | material | materiel | material | materiel | material | material | material |
| material | 1-1 | 2-1 | 3-1 | 4-1 | 5-1 | 6-1 | NG1-1 | NG2-1 | NG3-1 |
| Ink set | Ink set 1 | | | | | | | | |
| Transfer | ⊚ | ⊚ | ⊚ | ⊚ | ◯ | ⊚ | ⊚ | X | ⊚ |
| material | | | | | | | | | |
| stability | | | | | | | | | |
| Pattern clarity | ◯ | ◯ | ◯ | ◯ | ◯ | ◯ | X | X | ◯ |
| Pattern | ⊚ | ⊚ | ⊚ | ⊚ | ◯ | ◯ | X | X | ◯ |
| stretchability | | | | | | | | | |
| Continuous | ◯ | ◯ | ◯ | ◯ | ◯ | ◯ | ◯ | ◯ | X |
| transferability | | | | | | | | | |
| Washing | ◯ | ⊚ | ◯ | ◯ | ◯ | ◯ | X | X | ◯ |
| fastness | | | | | | | | | |

TABLE 5

| | Example | Example | Example | Example | Example | Example | Comparative | Comparative | Comparative |
|---|---|---|---|---|---|---|---|---|---|
| | 7 | 8 | 9 | 10 | 11 | 12 | Example 4 | Example 5 | Example 6 |
| | Transfer | Transfer | Transfer | Transfer | Transfer | Transfer | Transfer | Transfer | Transfer |
| Transfer | material | material | material | material | material | material | material | material | material |
| material | 1-2 | 2-2 | 3-2 | 4-2 | 5-2 | 6-2 | NG1-2 | NG2-2 | NG3-2 |
| Ink set | Ink set 2 | | | | | | | | |
| Transfer | ⊚ | ⊚ | ⊚ | ⊚ | ◯ | ⊚ | ⊚ | X | ⊚ |
| material | | | | | | | | | |
| Pattern clarity | ◯ | ◯ | ◯ | ◯ | ◯ | ◯ | X | X | ◯ |
| Pattern | ⊚ | ⊚ | ⊚ | ⊚ | ◯ | ◯ | X | X | ◯ |
| stretchability | | | | | | | | | |
| Continuous | ◯ | ◯ | ◯ | ◯ | ◯ | ◯ | ◯ | ◯ | X |
| transferability | | | | | | | | | |
| Washing | ◯ | ⊚ | ◯ | ◯ | ◯ | ◯ | X | X | ◯ |
| fastness | | | | | | | | | |

(Transfer Material Stability)

To check the status of adhesion between the hot melt adhesive layer and post hoc printed image layer of the transfer material obtained, or between the hot melt adhesive layer and the specified-image layer, a gummed tape on its adhesive face was applied to the hot melt adhesive layer formation side of each transfer material, and the gummed tape was removed from the transfer material, after which patterns and letters by the post hoc printed image layer or specified-image layer were visually checked to evaluate the influence of thermal transfer.

⊚: No problem with any pattern or letter.

◯: Partial lifting in patterns and letters, but not considered to have an influence in case of thermal transfer.

X: Detachment of all or considerable portions of patterns and letters from the substrate; use as a transfer material is unacceptable.

(Pattern Clarity)

Thermally transferred patterns on T-shirts were checked visually.

◯: All patterns and letters (all in gray) were clear.

X: All or portions of patterns and letters failed to be transferred to T-shirts or dropped from T-shirts, and were unidentifiable.

(Pattern Stretchability)

T-shirt portions with thermally transferred patterns were pulled to check for stretchability.

⊚: No cracking or dropping in any pattern or letter; no problem.

◯: Partial cracking.

X: Entire cracking and/or dropping.

(Continuous Transferability)

Transfer materials of 30 units were continuously used in transferring by heat pressurization under the same conditions, and the workability was checked.

◯: All the 30 units of transfer materials permitted similar heat pressurization transfer.

X: Thermally molten adhesive layer ink adhered to hot press, transfer material or T-shirt, affecting the workability.

(Washing Fastness)

A repeated washing test was performed in 30 repeats using the JIS L-1930C4M method to check the dropping and cracking of thermally transferred patterns and letters from T-shirts.

⊚: No cracking or dropping in any pattern or letter; no problem.

◯: Partial cracking.

X: Entire cracking and/or dropping.

(Adhesiveness of Post Hoc Printed Image Layer and Hot Melt Adhesive Layer Portion to T-Shirts)

The T-shirts with thermally transferred patterns in Examples 1 to 5 and 7 to 11 were tested as follows: The patterned portion by the post hoc printed image layer and a portion including the hot melt adhesive layer portion surrounding the periphery of the patterned portion by the post hoc printed image layer were cut, and the exposed cross-sectional portions were checked to determine whether the patterned portion by the post hoc printed image layer and the hot melt adhesive layer portion surrounding its periphery could be detached from the T-shirt using a pair of tweezers.

In all the Examples, the portion where the hot melt adhesive layer was in contact with the T-shirt was hardly detachable, because of strong adhesion to the T-shirt, using a pair of tweezers, whereas the portion where the post hoc printed image layer was in contact with the T-shirt was detachable to some extent using a pair of tweezers because its adhesion to the T-shirt was weaker than that of the hot melt adhesive layer.

Transfer Materials 7-1 and 7-2

Elevated temperature release layers were provided on the substrates in the same manner as with transfer materials 1-1 and 1-2, and the adhesive layer ink A was printed on each of ten post hoc printing areas specified on the each of rectangles of the elevated temperature release layers using a 100-mesh screen plate, to provide hot melt adhesive layers. The ten hot melt adhesive layers on any one of the rectangles of the elevated temperature release layer are spaced each other.

The common printed images or individual printed images shown below were formed by printing as post hoc printed image layers on the each of the ten hot melt adhesive layers on the each of rectangles using the ink jet printer apparatus filled with an energy ray curable ink jet ink in the same manner as with transfer materials 1-1 and 1-2.

On three hot melt adhesive layers, reversed images of patterns “Made in Japan”, “100% cotton”, and “Please use a cleaning net” as the common printed images were formed respectively. On other six hot melt adhesive layers, reversed images of patterns specified with symbol numbers 141, 200, 300, 445, 520, and 600 as defined by JIS L0001 as the common printed images were formed respectively. On remaining one hot melt adhesive layers, reversed images for size indication was formed (“XL” in the nine rectangles on the 1st line from above out of the 45 rectangles, “L” in the nine rectangles on the 2nd line, “M” in the nine rectangles on the 3rd line, “S” in the nine rectangles on the 4th line, and “XS” in the nine rectangles on the 5th line).

The periphery of each of the ten hot melt adhesive layers on the each of rectangles was formed to protrude by 0.5 to 1.0 mm in width from the periphery of the post hoc printed image layer which would be formed afterwards.

Thereafter, the substrates were cut along the rectangles of the elevated temperature release layers to obtain nine units for each size indication, namely a total of 45 units of transfer materials 7-1 and 7-2.

### Examples 13 and 14

Transfer materials 7-1 and 7-2 obtained as described above were each heated and pressurized at 180 degrees C. and 35 kPa for 10 seconds using a hot press, while the post hoc printed image layer was in contact with the specified portion of the white cotton T-shirt, the substrate was removed from the white cotton T-shirt while remaining hot.

No hot melt adhesive layer portions were formed anywhere other than the area corresponding to the post hoc printing area on the white cotton T-shirt. To the area corresponding to the post hoc printing area on the white cotton T-shirt, the hot melt adhesive layer portions were fusion bonded and the post hoc printed image layer was transferred and fixed.

Transfer materials 7-1 and 7-2 were equal to transfer materials 1-1 and 1-2 in stability, continuous transferability, and, post-transfer pattern clarity and washing fastness. And transfer materials 7-1 and 7-2 were superior to transfer materials 1-1 and 1-2 in stretchability, texture and air permeability of the post hoc printed image layer transferred T-shirt.

What is claimed is:

1. A manufacturing process for an article bearing a transferred printed image comprising:
an adhesive layer portion formation step for forming a hot melt adhesive layer portion on one or more specified post hoc printing areas in a specified face of a substrate, directly or via another layer, so that it can be removed from the substrate,
a post hoc printed image layer formation step for forming a post hoc printed image layer for showing a desired image on the adhesive layer portion by plateless printing, and
a transfer step for fusion bonding of the adhesive layer portion to the object article by heating the adhesive layer portion and post hoc printed image layer and pressing them against the object article, while the post hoc printed image layer is in contact with the object article, to fix the adhesive layer portion and post hoc printed image layer to the object article,
wherein the adhesive layer portion fixed to the object article and cooled is transparent or translucent, and a desired image shown by the post hoc printed image layer is allowed to be recognized or distinguished through the adhesive layer portion, while the substrate has been removed.

2. The process according to claim 1, wherein no hot melt adhesive layer portion is formed in at least part of other area than the area corresponding to the post hoc printing area in the specified face of the substrate.

3. The process according to claim 1, wherein no hot melt adhesive layer portion is formed anywhere other than the area corresponding to the post hoc printing area in the specified face of the substrate.

4. The process according to claim 1, wherein the plateless printing of the post hoc printed image layer on the hot melt adhesive layer portion is performed so that the hot melt adhesive layer portion will be present in a periphery of the post hoc printed image layer as protrusion.

5. The process according to claim 1, wherein the formation of the post hoc printed image layer for showing a desired image by plateless printing is achieved by ink jet printing.

6. The process according to claim 1, wherein the formation of the post hoc printed image layer for showing a desired image by plateless printing is achieved by printing to form a resin film.

7. The process according to claim 6, wherein the resin film is formed on the basis of an energy ray curable ink jet ink composition.

8. The process according to claim 6, wherein the resin film is a non-hot-melting resin film.

9. The process according to claim 8, wherein the hot melt adhesive layer portion and the resin film each comprises a urethane-series resin and can adhere firmly to each other.

10. The process according to claim 6, wherein the fixing force of the post hoc printed image layer by the resin film in a cooled state following the transfer step to the object article is lower than the fixing force of the hot melt adhesive layer portion, and the hot melt adhesive layer portion of the front side of the post hoc printed image layer retains the post hoc printed image layer by the resin film to the object article together with the hot melt adhesive layer portion in direct bonding to the object article in the periphery of the post hoc printed image layer.

11. The process according to claim 1 further comprising a specified-image layer formation step for forming a specified-image layer on one or more specified specified-image layer areas in the specified face of the substrate directly or via another layer, or on one or more specified specified-image layer areas in the hot melt adhesive layer portion, in a specified design, before the post hoc printed image layer formation step.

12. An article comprising:
an object article, a printed image layer by resin film in close contact with the object article, a hot melt adhesive layer portion covering the front side of the printed image layer, and a hot melt adhesive layer portion directly bonded to the object article in a periphery of the printed image layer, wherein the fixing force of the printed image layer to the object article is lower than the fixing force of the hot melt adhesive layer portion, and the hot melt adhesive layer portion of the front side of the printed image layer retains the printed image layer by the resin film to the object article together with the hot melt adhesive layer portion in direct bonding to the object article in a periphery of the printed image layer, and wherein the hot melt adhesive layer portion is transparent or translucent, and the desired image shown by the printed image layer can be recognized or distinguished through the hot melt adhesive layer portion.

13. A transfer material comprising:
a substrate,
a hot melt adhesive layer portion formed on one or more specified post hoc printing areas in a specified face of the substrate, directly or via another layer, so that it can be removed from the substrate, and
a post hoc printed image layer for showing a desired image formed on the adhesive layer portion by plateless printing;
wherein the adhesive layer portion is fusion bonded to the object article by heating the adhesive layer portion and post hoc printed image layer and pressing them against the object article, while the post hoc printed image layer is in contact with an object article,
the adhesive layer portion is transparent or translucent, while the adhesive layer portion and post hoc printed image layer are fixed to the object article and cooled, and the desired image shown by the post hoc printed image layer can be recognized or distinguished through the adhesive layer portion, while the substrate has been removed.

14. The transfer material according to claim 13, wherein at least part of other area than the area corresponding to the post hoc printing area in the specified face of the substrate has no hot melt adhesive layer portion.

15. The transfer material according to claim 13, wherein other area than the area corresponding to the post hoc printing area in the specified face of the substrate has no hot melt adhesive layer portion.

16. The transfer material according to claim 13, wherein the hot melt adhesive layer portion is present in a periphery of the post hoc printed image layer as protrusion.

17. The transfer material according to claim 13, wherein the post hoc printed image layer for showing the desired image is formed of a resin film.

18. The transfer material according to claim 17, wherein the hot melt adhesive layer portion and the resin film each comprise a urethane-series resin and adhere firmly to each other.

19. The transfer material according to claim 17, wherein the adhesive layer portion is fusion bonded to the object article by heating the adhesive layer portion and post hoc printed image layer and pressing them against the object article, while the post hoc printed image layer is in contact with the object article;
the fixing force for the object article of the post hoc printed image layer by the resin film is lower than the fixing force of the hot melt adhesive layer portion, while the adhesive layer portion and post hoc printed image layer are fixed to the object article and cooled;
and the hot melt adhesive layer portion of the front side of the post hoc printed image layer, together with the hot melt adhesive layer portion directly bonded to the object article in a periphery of the post hoc printed image layer, retain the post hoc printed image layer by the resin film to the object article.

20. The transfer material according to claim 13 further comprising a specified-image layer formed on one or more specified specified-image layer areas in the specified face of the substrate directly or via another layer, or on one or more specified specified-image layer areas in the hot melt adhesive layer portion, in a specified design.
